(19) United States
(12) Patent Application Publication
(10) Pub. No.: US 2025/0326639 A1
(43) Pub. Date: Oct. 23, 2025

(54) METHOD FOR PRODUCING HYDROGEN PEROXIDE

(71) Applicant: ARKEMA FRANCE, Colombes (FR)

(72) Inventors: Abdelatif BABA-AHMED, Pierre-Benite (FR); David ANDRE, Pierre-Benite (FR); Laurent WENDLINGER, Pierre-Benite (FR)

(73) Assignee: ARKEMA FRANCE, Colombes (FR)

(21) Appl. No.: 18/868,254

(22) PCT Filed: Oct. 20, 2023
(86) PCT No.: PCT/FR2023/051647

§ 371 Date: Nov. 22, 2024

(30) Foreign Application Priority Data
Oct. 25, 2022 (FR) 2211085

(51) Int. Cl. C01B 15/023

(52) U.S. Cl. CPC C01B 15/023

(57) ABSTRACT

The present invention relates to a process for producing hydrogen peroxide by the AO process, comprising the two alternating steps of: hydrogenation of a working solution in the presence of a catalyst, said working solution containing at least one quinone dissolved in at least one organic solvent, in order to obtain at least one corresponding hydroquinone; and oxidation of said at least one hydroquinone;
the solvent corresponding to formula (I) below:

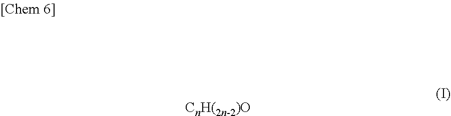

in which n is an integer greater than or equal to 8.

The present invention relates to a process for producing hydrogen peroxide from a quinone using, as organic solvent, a lactone as described below.

The invention also relates to the use of at least one organic solvent, as defined below, to dissolve a quinone, for the production of hydrogen peroxide.

The most common process for producing hydrogen peroxide is the anthraquinone process. During such a process, also called a cyclic autoxidation (AO) process, a quinone is dissolved in an appropriate mixture of organic solvents, what is known as a working solution, and is hydrogenated to form the corresponding hydroquinone. The hydroquinone is then reoxidized to quinone with oxygen (generally air) with simultaneous formation of hydrogen peroxide, which can then be extracted with water while the quinone is returned with the working solution to the hydrogenation step.

The anthraquinone process is widely described in the literature, for example in Kirk-Othmer, “Encyclopedia of Chemical Technology”, 49 Ed., 1993, Vol. 13, pp. 961-995.

So that the process operates correctly, it is necessary to use a solvent mixture for the working solution in which both the quinones and the hydroquinones are soluble. Consequently, the solvent mixture in the working solution generally comprises one or more solvents for quinones and one or more solvents for hydroquinones. The quinones readily dissolve in nonpolar aromatic solvents, whereas the hydroquinones dissolve well in polar solvents.

For the quinones, various aromatic solvents are proposed in the literature, such as benzene, xylene (U.S. Pat. No. 2,158,525), trimethylbenzene (GB 747 190), tetramethylbenzene (WO 2001/098204) and mixtures of polyalkylated benzenes (U.S. Pat. No. 3,3281,28, EP 3 342 750, FR 1 406 409).

In addition, certain nitrogen-based compounds are also known as solvents for the hydroquinones. The uses of carboxylic acid amides (U.S. Pat. No. 4,046,868), substituted ureas (U.S. Pat. No. 3,767,778), alkyl-substituted pyrrolidones (U.S. Pat. No. 4,394,369) and alkyl-substituted caprolactams (EP 0 286 610) are described in the literature.

However, the aromatic solvents already proposed in the literature are most often flammable and produce explosive vapours when they are mixed with oxygen or air (entailing serious risks of fire and explosion in a large-scale commercial plant).

Furthermore, such organic solvents also have the disadvantage of being synthesized from raw materials that are often costly and/or not environmentally friendly.

In view of the above, there is therefore a real need to use an appropriate solvent, particularly a biobased and renewable solvent, for the production of hydrogen peroxide, in order to reduce the costs of the process and to improve its performance levels in terms of safety and productivity.

In other words, one of the aims of the present invention is to in particular improve the performance levels of a process for producing hydrogen peroxide.

A subject of the present invention is therefore notably a process for producing hydrogen peroxide, comprising at least the two alternating steps of:
hydrogenation of a working solution in the presence of one or more catalysts, said working solution comprising at least one quinone dissolved in at least one organic solvent, in order to obtain at least one corresponding hydroquinone; and
oxidation of said at least one hydroquinone;
said organic solvent being a lactone corresponding to formula (I) below:

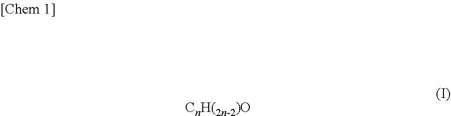

in which n is an integer greater than or equal to 8.

The present invention thus makes it possible to achieve the objectives as described above by virtue of the use of a solvent of formula (I) having the advantage of being biobased and renewable and the use of which in a process for producing hydrogen peroxide leads to an improvement in its performance levels, particularly in terms of safety and yield, while effectively reducing its costs.

The organic solvent of formula (I) thus makes it possible to improve the safety and the productivity of a hydrogen peroxide production unit.

The organic solvent also has the advantage of being easy to separate from the water during the step of extracting the hydrogen peroxide from the working solution.

The process according to the invention can advantageously result in a hydrogen peroxide solution having a high purity.

In particular, the hydroquinones have an increased solubility in such a solvent, thereby making it possible to carry out the process at a lower temperature, and therefore to reduce the costs associated with the production of hydrogen peroxide and the risks associated with the flammability of the solvent.

In addition, at an increased solubility, the reaction rates can increase, thereby making it possible to increase the productivity of the process.

The present invention also relates to the use of at least one organic solvent to dissolve a quinone in a working solution for the production of hydrogen peroxide, in which the organic solvent is a lactone corresponding to formula (I) as described above.

In particular, the invention relates to the use of at least one organic solvent of formula (I) to improve the solubility of a hydroquinone.

Other subjects, features, aspects and advantages of the invention will become even more clearly apparent on reading the description and the example which follows.

In the text hereinbelow, unless otherwise indicated, the limits of a range of values are included in that range, especially in the expressions “between” and “ranging from . . . to . . .”.

Furthermore, the expression “at least one” used in the present description is equivalent to the expression “one or more”.

In addition, the expression “at least” used in the present description is equivalent to the expression “greater than or equal to”.

Finally, in a manner known per se, a Cn or Cn compound or group denotes a compound or group containing n carbon atoms in its chemical structure.

### Working solution

As indicated above, the working solution comprises at least one organic solvent corresponding to a lactone of formula (I):

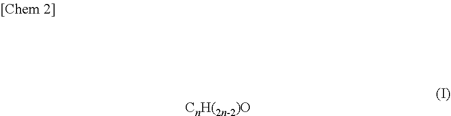

in which n is an integer greater than or equal to 8.

In accordance with the present invention, the term “lactone” means a class of compounds having at least one ester function in a ring.

According to a preferred general feature of the invention, in formula (I), n varies from 8 to 14, preferably from 9 to 13, even more preferentially from 10 to 13, in particular from 10 to 12.

According to another preferred general feature of the invention, the organic solvent is a lactone with a substituted or unsubstituted 5-membered ring (γ-lactone), or a substituted or unsubstituted 6-membered ring (δ-lactone), or a substituted or unsubstituted 7-membered ring (ε-lactone).

Preferably, the organic solvent is a lactone with a substituted or unsubstituted 5-membered ring, or a lactone with a substituted or unsubstituted 6-membered ring.

As substituents, mention may in particular be made of the substituents selected from the group consisting of a linear or branched alkyl group comprising from 1 to 10 carbon atoms, preferably from 1 to 8 carbon atoms, particularly methyl, ethyl, butyl and heptyl, a hydroxy group, an amine, a halogen atom such as the fluorine, chlorine, bromine or iodine atom, or combinations thereof.

Preferentially, when the organic solvent is a substituted lactone, then the substituent(s) may be one or more linear or branched alkyl groups comprising from 1 to 10 carbon atoms, preferably 1 to 8 carbon atoms, for example methyl, ethyl, propyl, butyl, pentyl, hexyl, heptyl, octyl, nonyl or decyl, and combinations thereof.

Preferably, the organic solvent has a flash point of greater than or equal to 60° C., thereby advantageously making it possible to reduce the fire risks associated with the flammability of the solvent.

More preferentially, the organic solvent has a flash point of greater than or equal to 62.5° C. and even more preferentially greater than or equal to 65° C.

The flash point may be determined using a closed-cup apparatus in accordance with the standard ASTM-D3278.

Preferably, n varies from 8 to 14, preferably from 10 to 12, and the organic solvent has a flash point of greater than or equal to 60° C.

More preferentially, n varies from 10 to 12 and the organic solvent has a flash point of greater than or equal to 65° C.

Preferably, the organic solvent has a vapour pressure of less than or equal to 450 Pa measured at a temperature of 20° C., thereby making it possible to always keep the vapours in the reactors below the explosive limits even when the reaction is carried out at high temperatures.

More preferentially, the organic solvent has a vapour pressure of less than or equal to 400 Pa, even more preferentially less than or equal to 350 Pa, measured at a temperature of 20° C. For example, the solvent of formula (I) may have a vapour pressure of less than or equal to 450 Pa, or less than or equal to 400 Pa, or less than or equal to 350 Pa, or less than or equal to 300 Pa, or less than or equal to 250 Pa, or less than or equal to 200 Pa, or less than or equal to 150 Pa, or less than or equal to 100 Pa, at 20° C.

The vapour pressure may be determined by ebulliometry in accordance with the standard ASTM-E1719.

Preferably, n varies from 8 to 14, preferably from 10 to 14, and the organic solvent has a vapour pressure of less than or equal to 450 Pa measured at a temperature of 20° C.

Advantageously, the organic solvent has a solubility in water of less than or equal to 2000 mg/kg at a temperature of 25° C.

Such a reduced solubility in water for the organic solvent makes it possible to reduce the loss of solvent particularly during the extraction step of the process (in which the oxidized working solution is treated with water in order to extract the hydrogen peroxide). In addition, such a reduced solubility in water for the organic solvent makes it possible to provide a crude hydrogen peroxide solution with a higher purity.

Preferably, the organic solvent is insoluble (or essentially insoluble) in water, and preferably has a solubility of less than or equal to 1500 mg/kg, preferably less than or equal to 1200 mg/kg, measured at a temperature of 25° C.

The solubility in water may be determined by coulometric Karl Fischer titration in accordance with the standard ASTM-D6304.

Preferably, n varies from 8 to 14, preferably from 10 to 14, and the organic solvent has a solubility of less than or equal to 1500 mg/kg, preferably less than or equal to 1200 mg/kg, measured at 25° C.

Advantageously, the organic solvent has a specific gravity of strictly less than 1, thereby facilitating the separation of the solvent from the water during the step of extracting the hydrogen peroxide from the working solution.

Preferably, the organic solvent has a specific gravity of less than or equal to 0.97, preferably varying from 0.89 to 0.97.

The specific gravity may be determined by means of a hydrometer in accordance with the standard ASTM-D891.

Preferably, n varies from 8 to 14, preferably from 10 to 14, and the organic solvent has a specific gravity of strictly less than 1, preferably a specific gravity of less than or equal to 0.97.

The organic solvent is preferably selected from the group consisting of γ-octalactone, δ-octalactone, γ-nonalactone, δ-nonalactone, 3-methyl-γ-octalactone, γ-decalactone, δ-decalactone, ε-decalactone, 4-methyl-y-nonalactone, 4-ethyl-γ-octalactone, 4-methyl-7-isopropyl-ε-heptalactone, γ-undecalactone, δ-undecalactone, 3-methyl-γ-decalactone, γ-dodecalactone, δ-dodecalactone, ε-dodecalactone, γ-tridecalactone, δ-tridecalactone, γ-tetradecalactone, δ-tetradecalactone, and mixtures thereof.

Preferably, the organic solvent is γ-octalactone, δ-dodecalactone, and mixtures thereof.

More preferentially, the organic solvent is δ-dodecalactone.

The organic solvent of formula (I) may be present in the working solution in an amount of from 70% to 99.9% by weight, and preferably from 80% to 99% by weight, relative to the total weight of the working solution.

For example, the organic solvent of formula (I) may be present in the working solution in an amount of from 70% to 75% by weight; or from 75% to 80% by weight; or from 80% to 85% by weight; or from 85% to 90% by weight; or from 90% to 95% by weight; or from 95% to 99.9% by weight, relative to the total weight of the working solution.

The working solution may comprise a single organic solvent of formula (I).

Alternatively, the working solution may comprise a mixture of organic solvents of formula (I), for example two or three or four organic solvents of formula (I).

The working solution used in the process according to the invention also comprises a quinone which is preferably an anthraquinone and more preferentially selected from an alkylanthraquinone or a tetrahydroalkylanthraquinone which is dissolved in the organic solvent of formula (I).

The term “quinone” or “quinone derivatives” means a class of organic compounds having a benzene ring on which two hydrogen atoms have been replaced by two oxygen atoms forming two carbonyl bonds.

For the sake of simplicity, the term “alkylanthraquinone” used in the description below will include both alkylanthraquinones and tetrahydroalkylanthraquinones.

The preferred alkyl substituents for the alkylanthraquinones include amyl groups such as 2-tert-amyl or 2-iso-sec-amyl, ethyl, isopropyl, n-butyl, sec-butyl, tert-butyl and 2-hexenyl, and it is particularly preferable to include the at least ethyl-substituted anthraquinones and/or tetrahydroanthraquinones. Thus, the preferred alkylanthraquinones include 2-ethylanthraquinone, 2-isopropylanthraquinone, 2-n-butylanthraquinone, 2-sec-butylanthraquinone, 2-tert-butylanthraquinone, 2-amylanthraquinone, 2-sec-amylanthraquinone, 2-tert-amylanthraquinone or mixtures thereof, and also 2-alkyl-5,6,7,8-tetrahydroanthraquinones and mixtures thereof with the corresponding 2-alkylanthraquinones.

According to one preferred embodiment, the alkylanthraquinone may be 2-ethylanthraquinone.

The quinone may be present in the working solution in an amount of from 0.1% to 30% by weight, and preferably from 1% to 20% by weight, relative to the total weight of the working solution.

For example, the quinone may be present in the working solution in an amount of from 0.1% to 1% by weight; or from 1% to 5% by weight; or from 5% to 10% by weight; or from 10% to 15% by weight; or from 15% to 20% by weight; or from 20% to 25% by weight; or from 25% to 30% by weight.

According to certain embodiments, the working solution comprises a single quinone.

Alternatively, the working solution comprises a mixture of quinones, for example two or three or four quinones.

The working solution according to the invention may also comprise an additional solvent that is different from the organic solvent of formula (I).

The additional solvent may be a solvent for dissolving the quinone or a solvent for dissolving the hydroquinone (formed after the hydrogenation of the quinone). One or more additional solvents may be present in the working solution. For example, a first additional solvent for dissolving the quinone and a second additional solvent for dissolving the hydroquinone may be present in the working solution.

The additional solvent may be present in the working solution according to a weight ratio relative to the organic solvent of formula (I) in the range from 0:1 to 3:1, preferably in the range from 0:1 to 2:1 and more preferentially in the range from 0:1 to 1:1.

In the case where the additional solvent is intended to dissolve the quinone (solvent for quinone), this solvent may be a nonpolar hydrocarbon preferably selected from aromatic, aliphatic or naphthenic hydrocarbons, the most preferred among which are aromatic hydrocarbons. The preferred solvents of this type include benzene, alkylated or polyalkylated benzenes such as tert-butylbenzene or trimethylbenzene, alkylated toluenes or naphthalenes such as tert-butyltoluene or methylnaphthalene. It is possible to use a commercial mixture of aromatic compounds sold under the name Aromatic Solvent 150 (also called solvent C10). Aromatic Solvent 150 bears the CAS number 64742-94-5 and is produced by distillation of aromatic streams derived from petroleum products. It is also known under other brand names such as Solvent Naphtha 150, Solvesso 150, Caromax 150, Shellsol A150 and Heavy Aromatic Solvent Naphtha 150.

In the case where the additional solvent is intended to dissolve the hydroquinone (solvent for hydroquinone), this solvent may be a polar organic solvent that is preferably insoluble in water. Such a solvent may be selected from alcohols, ureas, amides, caprolactams, esters, phosphorus-containing substances and pyrrolidones, and may comprise alkyl phosphates (for example trioctyl phosphate), alkyl phosphonates, alkylcyclohexanol esters (for example 2-methylcyclohexyl acetate), N,N-dialkylcarbonamides, tetraalkylureas (for example tetrabutylurea), N-alkyl-2-pyrrolidones and alcohols with a high boiling point, preferably having 8 to 9 carbon atoms (for example diisobutyl carbinol). The preferred solvents for hydroquinones are selected from alkyl phosphates, tetraalkylureas, alkylcyclohexanol esters and alcohols with a high boiling point.

Alternatively, the working solution according to the invention does not have any additional solvent.

Preferably, the working solution may consist of (or essentially consist of) the organic solvent of formula (I) and the quinone.

### Process for Producing Hydrogen Peroxide

As indicated above, the invention relates to a process for producing hydrogen peroxide, in particular by the AO process. Such a process comprises alternating steps of hydrogenation and oxidation of the working solution described above.

In other words, preferably, the invention relates to a process for producing hydrogen peroxide by the AO process, comprising at least the two alternating steps of:
hydrogenation of a working solution in the presence of one or more catalysts, said working solution comprising at least one quinone dissolved in at least one organic solvent, in order to obtain at least one corresponding hydroquinone; and
oxidation of said at least one hydroquinone;
the organic solvent being a lactone corresponding to formula (I) below:

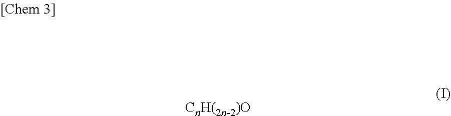

in which n is an integer greater than or equal to 8.

The hydrogenation step may be carried out by bringing the working solution into contact with gaseous hydrogen. During this step, the quinone is hydrogenated to form a corresponding hydroquinone. This step is carried out in the presence of a catalyst. Such a catalyst may, for example, be a metal selected from nickel, palladium, platinum, rhodium, ruthenium, gold, silver or mixtures thereof. The preferred metals are palladium, platinum and gold, particularly preferred among which are palladium or mixtures comprising at least 50% by weight of palladium.

According to a preferred embodiment, the catalyst may be either in a free form, for example palladium black suspended in the working solution, or deposited on a solid support such as particles used in the form of a suspension or a fixed bed.

According to another preferred embodiment, the catalyst may be in the form of an active metal on a monolithic support, for example, as described in patents U.S. Pat. Nos. 4,552,748 and 5,063,043.

The preferred support materials may be selected from alumina, silica, aluminosilicates (silica-alumina), activated magnesia, titanium dioxide, carbon black, activated carbon, zeolites, ion exchange resins, polymer substrates, metal substrates, an alkaline earth metal carbonate or the like or combinations thereof. The percentage concentration of the metal in the supported catalysts may be in the range from 0.1% to 50% by weight, but is preferably in the range from 0.2% to 5% by weight.

The hydrogenation step may be carried out at a temperature of from 20° C. to 120° C., and preferably from 30° C. to 90° C.

In addition, such a step may be carried out at an absolute pressure of from 100 to 1200 kPa, and preferably from 150 to around 600 kPa.

Preferably, the hydrogenation step may be carried out either in a slurry reactor, or in a fixed-bed reactor.

After the hydrogenation step, the working solution (now comprising the hydroquinone) is subjected to an oxidation step. During this step, the hydroquinone is transformed into quinone while hydrogen peroxide is produced. Such a step is carried out in the presence of oxygen. As oxygen source, use may be made of molecular oxygen, a gas enriched in oxygen, air or any other appropriate oxygen compound that makes it possible to produce hydrogen peroxide and to oxidize the hydroquinone.

This step may be carried out, for example, in a bubble column reactor, in which the oxygen source and the working solution can pass in cocurrent or in countercurrent. The bubble column reactor may be free of internal devices or preferably contain internal devices in the form of packing plates or sieves.

The oxidation step may be carried out at a temperature of from 20° C. to 100° C., and preferably from 40° C. to 75° C.

In addition, such a step may be carried out at an absolute pressure of from 50 to 1500 kPa, and preferably from 100 to around 700 kPa.

The oxidation step is preferably carried out with an excess of oxygen, such that preferably more than 90%, in particular more than 95%, of the hydroquinone contained in the working solution is converted to the quinone form.

At the end of this step, the working solution may have a concentration of hydrogen peroxide of from 0.5% to 2.5% by weight and preferably from 0.8% to 1.9% by weight. For example, the working solution may have a concentration of hydrogen peroxide of from 0.5% to 1% by weight; or from 1% to 1.5% by weight; or from 1.5% to 2% by weight; or from 2% to 2.5% by weight.

After this step, the process according to the present invention may comprise a step of recovering the hydrogen peroxide in a crude hydrogen peroxide solution. This step may be carried out by extracting the working solution resulting from the oxidation step with water. This step may be carried out in perforated-plate extraction column, packed columns, pulsed packed columns and liquid-liquid centrifugal extractors.

The efficiency of the extraction is heavily influenced by the distribution coefficient, which depends on the composition of the working solution (for example, the type and the concentration of the solvents and the accumulation of degraded compounds). Efficient extraction may take more than 95% of the hydrogen peroxide of the working solution from said solution.

At the end of this step, the crude hydrogen peroxide solution may have a concentration of hydrogen peroxide of from 25% to 55% by weight and preferably from 30% to 50% by weight.

The solution resulting from the recovery of the hydrogen peroxide (and comprising the organic solvent of formula (I) and the quinone) may then be reused in the hydrogenation step. However, it is preferable, before reusing said solution in the hydrogenation step, to adjust its water content. Given that the solubility of water in the working solution depends on the temperature, the moisture content of said working solution can be adjusted by performing the extraction step at temperatures that are compatible with the extraction performance, by separating the dispersed water, then by increasing the temperature of the working solution before it reaches the hydrogenation step. The working solution may also be dried by using the exhaust gas (discharged gas) from the oxidation step. Alternatively, the working solution leaving the extraction column may initially be rid of entrained water in a water separator and then passed through an aqueous potassium carbonate solution for drying.

The fact that the organic solvent according to the invention preferably has a solubility in water of equal to or less than 2000 mg/kg makes it possible to reduce the loss of organic solvent during the extraction. In addition, such a reduced solubility in water for the organic solvent makes it possible to provide a crude hydrogen peroxide solution with a higher purity.

On the one hand, after the extraction step, the crude hydrogen peroxide solution may be treated (washed) in order to eliminate impurities such as the entrained droplets of working solution and dissolved organic materials. This treatment may comprise, for example, in coalescence, a liquid-liquid extraction, treatment with resins or any other treatment that is well known in the chemical industry. The purified crude product may then be introduced into a distillation unit, where it may be further purified and concentrated to the usual commercial concentration (for example from 50% to 70% by weight of hydrogen peroxide).

On the other hand, the working solution after the extraction step may be recycled into the hydrogenation step in order to continue the hydrogen peroxide production cycle. As degradation products are formed (from the quinone/hydroquinone compounds and from the solvents), the working solution should preferably be treated/regenerated in order to avoid any deterioration of the performance levels of the process. Numerous methods have been suggested for purifying the working solution and regenerating the active quinone from the degradation products of the quinone. For example, treatment with alkaline substances (aqueous solution of sodium hydroxide or potassium hydroxide, calcium hydroxide, ammonia or amines), treatment with sodium aluminium silicates and extraction with active aluminium oxide.

The working solution should also preferably be washed (usually with slightly acidic water) before being sent back into the process.

Preferably, the process according to the invention is a process for producing hydrogen peroxide by the AO process, comprising at least the two alternating steps of:
hydrogenation of a working solution in the presence of one or more catalysts, said working solution comprising at least 2-ethylanthraquinone dissolved in at least one organic solvent, in order to obtain at least one corresponding hydroquinone; and
oxidation of said at least one hydroquinone;
said organic solvent being a lactone with a substituted or unsubstituted 5-membered ring, or a lactone with a substituted or unsubstituted 6-membered ring, preferably a lactone selected from the group consisting of γ-octalactone, Ia δ-dodecalactone, and mixtures thereof.

### Uses

The present invention also relates to the use of at least one organic solvent to dissolve a quinone in a working solution for the production of hydrogen peroxide, in which the organic solvent is a lactone corresponding to formula (I) as described above.

In other words, the organic solvent as described above is used to dissolve a quinone in a working solution for the production of hydrogen peroxide.

Preferably, the present invention relates to the use of an organic solvent to dissolve a quinone in a working solution for the production of hydrogen peroxide, in which the organic solvent is a lactone corresponding to formula (I) as described above.

In particular, the invention relates to the use of at least one organic solvent as described above to improve the solubility of a hydroquinone, preferably 2-ethyltetrahydroanthrahydroquinone.

The hydroquinone is notably formed after hydrogenation of the corresponding quinone.

The invention is illustrated in more detail in the following nonlimiting examples.

### EXAMPLES

The following examples illustrate the invention without limiting it.

### Solubility Tests of the Quinones and Hydroquinones in Different Solvents

In the following examples, the solubilities of 2-ethyltetrahydroanthrahydroquinone (2-THEAHQ) were tested in different solvents in accordance with the protocols detailed below.

### 2-Ethyltetrahydroanthrahydroquinone Solubility Protocol

For 2-ethyltetrahydroanthrahydroquinone, the solubilities were determined by dissolving a weighed amount of the parent quinone in the tested solvent. After the addition of a Pd-based catalyst to the solution, the mixture was hydrogenated until hydrogen absorption ceases, and then cooled until precipitation occurs.

The samples were analysed by liquid chromatography. Reference mixtures were prepared for calibration.

The solubility of 2-ethyltetrahydroanthrahydroquinone (2-THEAHQ) was measured in two lactones of formula (I) according to the invention, in two lactones outside of the invention corresponding to formula (C) CₙH₍₂ₙ₋₂₎O, in which n represents an integer strictly less than 8, and in different prior art solvents.

In the prior art solvents, the solubility of 2-ethyltetrahydroanthrahydroquinone was measured, on the one hand, in accordance with the protocol indicated above and, on the other hand, as indicated in Canadian patent CA573780 (Jul. 4, 1959).

TABLE 1

| Tested | Solubility of |
|---|---|
| solvents | 2-THEAHQ (g/l) |
| γ-octalactone | 281 |
| δ-dodecalactone | 276 |
| β-propiolactone | 70 |
| β-butyrolactone | 193 |

TABLE 2

| | Solubility of 2-THEAHQ (g/l) | |
|---|---|---|
| Tested | According to | |
| solvents | the protocol | CA573780 |
| 1,2-dichlorobenzene | 15 | 19 |
| diisobutyl ketone | 97 | — |
| 2-methylcyclohexyl acetate | 153 | — |
| 1,2-dichlorobenzene/diisobutyl | 53 | 38 |
| ketone (25/75 vol.) | | |
| 1,2-dichlorobenzene/diisobutyl | 32 | 36 |
| ketone (50/50 vol.) | | |
| 1,2-dichlorobenzene/diisobutyl | 22 | 32 |
| ketone (75/25 vol.) | | |
| 1,2-dichlorobenzene/2-methylcyclohexyl | 77 | 51 |
| acetate (25/75 vol.) | | |
| 1,2-dichlorobenzene/2-methylcyclohexyl | 42 | 36 |
| acetate (50/50 vol.) | | |
| 1,2-dichlorobenzene/2-methylcyclohexyl | 25 | 23.5 |
| acetate (75/25 vol.) | | |

A result of this is that the solubilities of 2-ethyltetrahydroanthrahydroquinone (2-THEAHQ) are greater in a working solution comprising at least one organic solvent according to the invention (belonging to formula (I) according to the invention) than in a working solution comprising at least one organic solvent belonging to the same class of compounds but not corresponding to formula (I) according to the invention, under the same conditions.

In the same way, the solubilities of 2-ethyltetrahydroanthrahydroquinone (2-THEAHQ) are greater in a working solution comprising at least one organic solvent according to the invention (belonging to formula (I) according to the invention) than in a working solution comprising at least one organic solvent of different structure that is commonly used in the literature.

Table 3 below compares the different properties of an organic solvent according to the invention and of lactones of formula (C) where n is strictly less than 8 and of solvents commonly used in the literature.

The flash point may be determined using a closed-cup apparatus in accordance with the standard ASTM-D3278.

The vapour pressure may be determined by ebulliometry in accordance with the standard ASTM-E1719.

The specific gravity may be determined by means of a hydrometer in accordance with the standard ASTM-D891.

The solubility in water may be determined by coulometric Karl Fischer titration in accordance with the standard ASTM-D6304.

A low specific gravity (as much below 1 as possible) facilitates the separation of the solvent from the water. This is useful during the step of extracting the hydrogen peroxide from the working solution.

A low solubility in water of the solvent is considered to be a very important property in this application. It makes it possible to reduce the loss of solvent particularly during the extraction step of the process (in which the oxidized working solution is treated with water in order to extract the hydrogen peroxide). Furthermore, this reduction in solubility in water of the organic solvent makes it possible to obtain a crude hydrogen peroxide solution with a greater purity.

TABLE 3

| | Flash | Vapour | | Solubility |
|---|---|---|---|---|
| Tested | point | pressure | Specific | in water |
| solvents | (° C.) | (Pa) | gravity | (mg/kg) |
| δ-dodecalactone | 168 | 0.05 | 0.962 | 1113 |
| β-butyrolactone (*) | 74 | 212 | 1.076 | 158.9 10³ |
| γ-butyrolactone (*) | 97 | 87 | 1.136 | 484.3 10³ |
| β-propiolactone (*) | 70 | 418 | 1.137 | 201.2 10³ |

(*) outside the invention

As shown by Table 3, the compounds according to the invention also have a certain number of other favourable properties making it possible to improve the optimization of the process for producing hydrogen peroxide.

1. Process for producing hydrogen peroxide, comprising at least the two alternating steps of:
hydrogenation of a working solution in the presence of one or more catalysts, said working solution comprising at least one quinone dissolved in at least one organic solvent, in order to obtain at least one corresponding hydroquinone; and
oxidation of said at least one hydroquinone;
wherein the organic solvent is a lactone corresponding to formula (I) below: 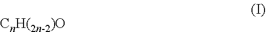
in which n is an integer greater than or equal to 8.

2. Process according to claim 1, wherein n varies from 8 to 14.

3. Process according to claim 1, wherein the organic solvent is a lactone with a substituted or unsubstituted 5-membered ring, or a substituted or unsubstituted 6-membered ring, or a substituted or unsubstituted 7-membered ring.

4. Process according to claim 1, wherein the organic solvent has a flash point of greater than or equal to 60° C.

5. Process according to claim 1, wherein the organic solvent has a vapour pressure of less than or equal to 450 Pa. measured at a temperature of 20° C.

6. Process according to claim 1, wherein the organic solvent has a solubility in water of less than or equal to 2000 mg/kg, measured at a temperature of 25° C.

7. Process according to claim 1, wherein the organic solvent has a specific gravity of strictly less than 1.

8. Process according to claim 1, wherein the organic solvent is selected from the group consisting of γ-octalactone, δ-octalactone, γ-nonalactone, δ-nonalactone, 3-methyl-y-octalactone, γ-decalactone, δ-decalactone, ε-decalactone, 4-methyl-γ-nonalactone, 4-ethyl-γ-octalactone, 4-methyl-7-isopropyl-ε-heptalactone, γ-undecalactone, δ-undecalactone, 3-methyl-γ-decalactone, γ-dodecalactone, δ-dodecalactone, ε-dodecalactone, γ-tridecalactone, δ-tridecalactone, γ-tetradecalactone, δ-tetradecalactone, and mixtures thereof.

9. Process according to claim 1, characterized in wherein the organic solvent is δ-dodecalactone.

10. Process according to claim 1, wherein the quinone is an anthraquinone.

11. Process according to claim 1, characterized in wherein the working solution also comprises an additional solvent that is different from the organic solvent of formula (I).

12. Process according to claim 1, wherein the working solution consists of the organic solvent of formula (I) and the quinone.

13. A method comprising using at least one organic solvent to dissolve a quinone in a working solution for the production of hydrogen peroxide, in which the organic solvent is a lactone corresponding to formula (I) below: 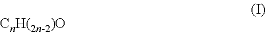
in which n is an integer greater than or equal to 8.

14. The method according to claim 13, wherein n varies from 8 to 14 and/or the organic solvent has a flash point of greater than or equal to 60° C.

15. A method comprising using at least one organic solvent of formula (I) below: 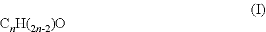
to improve the solubility of a hydroquinone.
